(19) United States
(12) Patent Application Publication
(10) Pub. No.: US 2016/0226266 A1
(43) Pub. Date: Aug. 4, 2016

(54) FAST CHARGING POWER BANK

(71) Applicant: Digipower Manufacturing Inc., New Taipei City (TW)

(72) Inventor: Min-Huang Huang, New Taipei City (TW)

(21) Appl. No.: 14/708,291

(22) Filed: May 10, 2015

(30) Foreign Application Priority Data
Jan. 29, 2015 (TW) 104201415

(51) Int. Cl. H02J 7/00

(52) U.S. Cl. CPC H02J 7/0013; H02J 7/0052; H02J 7/007

(57) ABSTRACT

A fast charging power bank is provided. The fast charging power bank includes a battery, input ports, and a charging control unit. The charging control unit includes boosters and a charging control circuit. Each of the input ports is configured to receive input power as charging power. The boosters are connected to each other in parallel and control currents of the input powers respectively to obtain fast charging power and supply the fast charging power to the battery. Each of the boosters is correspondingly connected to an independent one of the input ports to receive the charging power. The boosters step up voltages of the charging powers respectively and output a boosting voltage to a boost bus. The charging control circuit is connected between the boost bus and the battery and configured to convert the boosting voltage into a charging current for charging the battery.

### CROSS-REFERENCE TO RELATED APPLICATION

This application claims the priority benefit of Taiwan application serial no. 104201415, filed on Jan. 29, 2015. The entirety of the above-mentioned patent application is hereby incorporated by reference herein and made a part of this specification.

### BACKGROUND OF THE INVENTION

1. Field of the Invention

The invention relates to a power supply; more particularly, the invention relates to a fast charging power bank.

2. Description of Related Art

The rapid development of mobile apparatuses allows normal mobile apparatuses to be equipped with high-resolution screens, to take pictures, to display video clips, to access to a wireless internet connection, and so forth. Said functions of the mobile apparatuses often consume power of batteries in the mobile apparatuses at a fast pace. Users of the mobile apparatuses are frequently required to prepare an additional power bank for charging the mobile apparatus and avoiding depletion of power.

In general, the power bank often performs a charging action through one single micro universal serial bus (micro-USB) port. Subject to the specifications of the micro-USB port, the micro-USB port often encounters limitations on currents, which also poses an impact on the charging current of the power bank. In another aspect, the capacity of the existing power bank continues to increase and frequently reaches 5000 mAh or even 12000 mAh. If the power bank with the large capacity still performs the charging action by applying the charging current provided by one single micro-USB port, the charging time of the power bank may be excessively long, which may cause inconvenience to users.

### SUMMARY OF THE INVENTION

The invention is directed to a fast charging power bank capable of increasing a charging current in the power bank to reduce charging time.

In an embodiment of the invention, a fast charging power bank that includes at least one battery, a plurality of input ports, and a charging control unit is provided. The charging control unit includes a plurality of input boosters and a charging control circuit. The input ports are configured to respectively receive a plurality of input powers as a plurality of charging powers from a plurality of external power supplies. The input boosters are connected to each other in parallel. Each of the input boosters is correspondingly connected to an independent one of the input ports to receive one of the charging powers. An output terminal of each of the input boosters is connected to each other and connected to a boost bus. The input boosters respectively step up voltages of the charging powers to output a boosting voltage and control a current of each of the charging powers, so as to provide more significant energy and charge the at least one battery. Each of the input boosters controls the current of each of the charging powers to balance the input powers and prevent overload of the input powers. The charging control circuit is connected between the boost bus and the at least one battery. The charging control circuit is configured to control the boost bus and convert the boosting voltage into a charging current. The charging control unit also outputs the charging current to the at least one battery, so as to charge the at least one battery.

According to an embodiment of the invention, the fast charging power bank further includes a measurement circuit and a processing circuit. The measurement circuit is connected to the at least one battery to measure a voltage and a current of the at least one battery and generate a measurement signal. The processing circuit is connected to the input boosters, the charging control circuit, and the measurement circuit. The input boosters are respectively controlled by the processing circuit to generate the boosting voltage and control the currents of the charging powers. The processing circuit receives a measurement signal and controls the charging control circuit based on the measurement signal, so as to generate the charging current.

According to an embodiment of the invention, the processing circuit of the fast charging power bank is further connected to the input ports to detect the charging powers. The processing circuit controls the input boosters based on a plurality of detection results of the charging powers, so as to control the currents of the charging powers and control the input boosters to generate the boosting voltage.

According to an embodiment of the invention, the processing circuit of the fast charging power bank obtains a maximum stable power output by each of the external power supplies according to the detection result of each of the charging powers.

According to an embodiment of the invention, the processing circuit of the fast charging power bank controls a current of each of the input boosters to adjust the charging current.

According to an embodiment of the invention, the fast charging power bank further includes a discharging control unit. The discharging control unit includes a battery booster and a discharging control circuit. The battery booster is connected to the at least one battery and the processing circuit. The battery booster is controlled by the processing circuit to step up the voltage of the at least one battery and accordingly generate a discharging voltage. The discharging control circuit is connected to the battery booster and the processing circuit. The discharging control circuit is controlled by the processing circuit to output the discharging voltage and at least one discharging current to at least one mobile apparatus.

According to an embodiment of the invention, the fast charging power bank further includes at least one output port. The at least one output port is connected to the discharging control circuit to output the power of the at least one battery after the voltage of the at least one battery is stepped up. Besides, the at least one output port outputs said power to the at least one mobile apparatus. The discharging control circuit detects the at least one discharging current to perform an overload detection on the at least one output port.

According to an embodiment of the invention, the processing circuit of the fast charging power bank obtains a current capacity of the at least one battery according to the measurement signal. If the current capacity of the at least one battery is greater than an input threshold, the processing circuit controls the charging control circuit to stop generating the charging current. If the current capacity of the at least one battery is less than a battery threshold, the processing circuit controls the discharging control circuit to stop charging the at least one mobile apparatus.

According to an embodiment of the invention, in the fast charging power bank, the input threshold is the maximum allowable capacity of the at least one battery, and the battery threshold is the minimum allowable capacity of the at least one battery.

According to an embodiment of the invention, each of the input ports or each of the at least one output port is a universal serial bus (USB) port, and the USB port is a micro-USB port, a mini-USB port, or a USB type C port.

In light of the foregoing, the fast charging power bank is able to receive the input powers from the external power supplies through the input ports, so as to add up the powers. Hence, large charging current can be provided to the at least one battery in the power bank. Thereby, the charging action performed on the at least one battery can be accelerated, and the charging time of the at least one battery can be reduced. Moreover, each input booster is connected to one independent input port corresponding to the input booster to receive the charging power; accordingly, the processing circuit is able to control the current of each input booster, so as to control the voltage at the boost bus and adjust the charging current of the at least one battery.

Several exemplary embodiments accompanied with figures are described in detail below to further describe the invention in details.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a schematic block diagram illustrating a fast charging power bank according to an embodiment of the invention.

FIG. 2 is a schematic block diagram illustrating details of the fast charging power bank depicted in FIG. 1.

### DETAILED DESCRIPTION OF DISCLOSED EMBODIMENTS

Descriptions of the invention are given with reference to the exemplary embodiments illustrated with accompanied drawings, wherein same or similar parts are denoted with same reference numerals. In addition, whenever possible, identical or similar reference numbers stand for identical or similar elements in the figures and the embodiments.

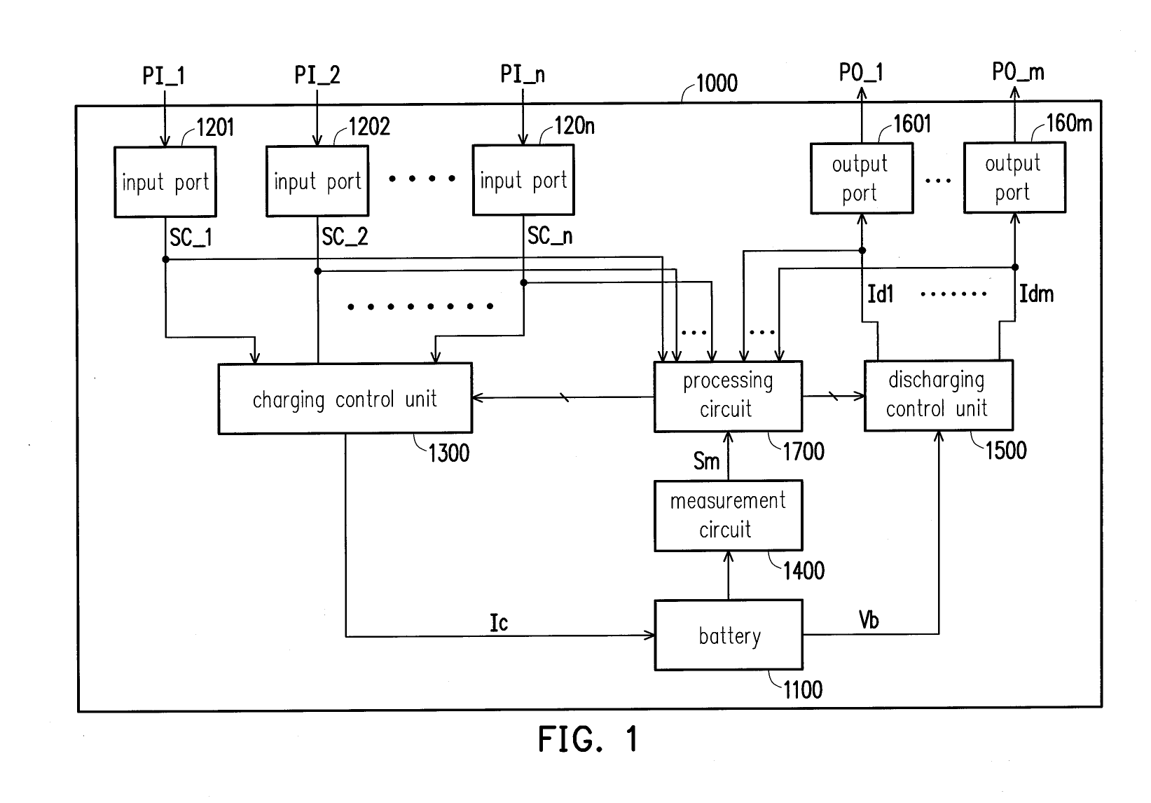

FIG. 1 is a schematic block diagram illustrating a fast charging power bank 1000 according to an embodiment of the invention. The fast charging power bank 1000 includes a battery 1100, a plurality of input ports 1201-120n, a charging control unit 1300, a measurement circuit 1400, a discharging control unit 1500, a plurality of output ports 1601-160m, and a processing circuit 1700.

The battery 1100 may stand for one single battery (or a battery device), a battery set, or a module that includes one or more batteries (or battery devices). Besides, the battery 1100 may be a rechargeable battery, such as a nickel-zinc battery, a nickel-metal hydride (NiMH) battery, a lithium ion battery, a lithium polymer battery, or a LiFePO₄ battery, which should however not be construed as a limitation to the invention.

The input ports 1201-120n are configured to respectively receive a plurality of input powers PI_1-PI_n as a plurality of charging powers SC_1-SC_n from a plurality of external power supplies (not shown) and supply the charging powers SC_1-SC_n to the charging control unit 1300. In an embodiment of the invention, the input ports 1201-120n may be USB input ports, but the invention is not limited thereto. As provided above, the input ports 1201-120n may be of various types, e.g., micro-USB input ports, mini-USB input ports, USB type C connection ports, etc.

The charging control unit 1300 respectively steps up voltages of the charging powers SC_1-SC_n (i.e., the input powers PI_1-PI_n) and converts the voltages into charging current Ic. The charging control unit 1300 also outputs the charging current Ic to the battery 1100, so as to charge the battery 1100.

The measurement circuit 1400 is connected to the battery 1100 to measure a voltage and a current of the battery 1100 and generate a measurement signal Sm.

The discharging control unit 1500 is connected to the battery 1100. After the discharging control unit 1500 steps up a voltage Vb of the battery 1100, the discharging control unit 1500 outputs the voltage Vb to a load (not shown, e.g., a mobile apparatus) through the output ports 1601-160m to generate at least one of the discharging currents Id1-Idm.

The output ports 1601-160m are connected to the discharging control unit 1500 to receive the discharging currents Id1-Idm. The output ports 1601-160m output the discharging currents Id1-Idm to at least one mobile apparatus (not shown), so as to provide output powers PO_1-PO_m to at least one external mobile apparatus. According to an embodiment of the invention, the mobile apparatus may be a cell phone, a tablet PC, and so forth, and the invention is not limited thereto. In an embodiment of the invention, the output ports 1601-160m may be USB output ports, which should not be construed as a limitation to the invention. As described above, the output ports 1601-160m may be USB output ports of various types, e.g., USB output ports, USB type C connection ports, and so forth.

The processing circuit 1700 is connected to the input ports 1201-120n, the charging control unit 1300, the measurement circuit 1400, the discharging control unit 1500, and the output ports 1601-160m. The processing circuit 1700 is able to detect the charging powers SC_1-SC_n from the input ports 1201-120n, so as to detect whether the external power supply is connected to the input ports 1201-120n. For instance, the input ports 1201-120n are the USB input ports; hence, when the external power supply is connected to the input port 1201, the external power supply can provide the voltage (e.g., at 5 volts) of the charging power SC_1 to the processing circuit 1700 through the input port 1201. Thereby, the processing circuit 1700 can detect whether the external power supply is connected to the input ports 1201-120n according to the voltages of the charging powers SC_1-SC_n. Nevertheless, the invention should not be construed as limited to the embodiments set forth herein.

Besides, the processing circuit 1700 may learn the voltage and the current of the battery 1100 at present based on the measurement signal Sm generated by the measurement circuit 1400. According to the measurement signal Sm, the processing circuit 1700 obtains a current capacity of the battery 1100. If the current capacity of the battery 1100 is greater than an input threshold, the processing circuit 1700 controls the charging control unit 1300 to stop charging the battery 1100. That is, the charging control unit 1300 stops generating the charging current Ic. Thereby, dangers resulting from the excessive charging of the battery 1100 by the charging control unit 1300 can be prevented. By contrast, if the current capacity of the battery 1100 is less than a battery threshold, the processing circuit 1700 controls the discharging control unit 1500 to stop charging the external apparatus. That is, the discharging control unit 1500 switches off the outputs. Thereby, damages to the battery 110 can be prevented because the excessive discharging of the battery 1100 by the discharging control unit 1500 can be avoided. Here, the input threshold is greater than the battery threshold.

According to an embodiment of the invention, the input threshold can be the maximum allowable capacity of the battery 1100, and the battery threshold 1100 can be the minimum allowable capacity of the battery 1100; however, the invention is not limited thereto. In an embodiment of the invention, the maximum allowable capacity of the battery 1100 may be 100% of the capacity of the battery 1100, and the minimum allowable capacity of the battery 1100 can be 0% of the capacity of the battery 1100; however, the invention is not limited thereto.

In the previous embodiment, the measurement circuit 1400 may include a coulomb meter to measure the current capacity of the battery 1100. The measurement circuit 1400 may also be included in the processing circuit 1700. That is, the processing circuit 1700 may perform a voltage measurement function or a capacity measurement function, which should not be construed as a limitation to the invention.

In the previous embodiment of the invention, the processing circuit 1700 may be implemented in form of a micro processor, a digital signal processor (DSP), an application specific integrated circuit (ASIC), or a field programmable gate array (FPGA). The charging control unit 1300, the measurement circuit 1400, and the discharging control unit 1500 may be implemented in form of ASIC or FPGA. Here, the charging control unit 1300, the measurement circuit 1400, and the discharging control unit 1500 may be respectively formed on one individual circuit chip or may be partly or wholly formed on one integrated circuit chip, which should however not be construed as a limitation to the invention.

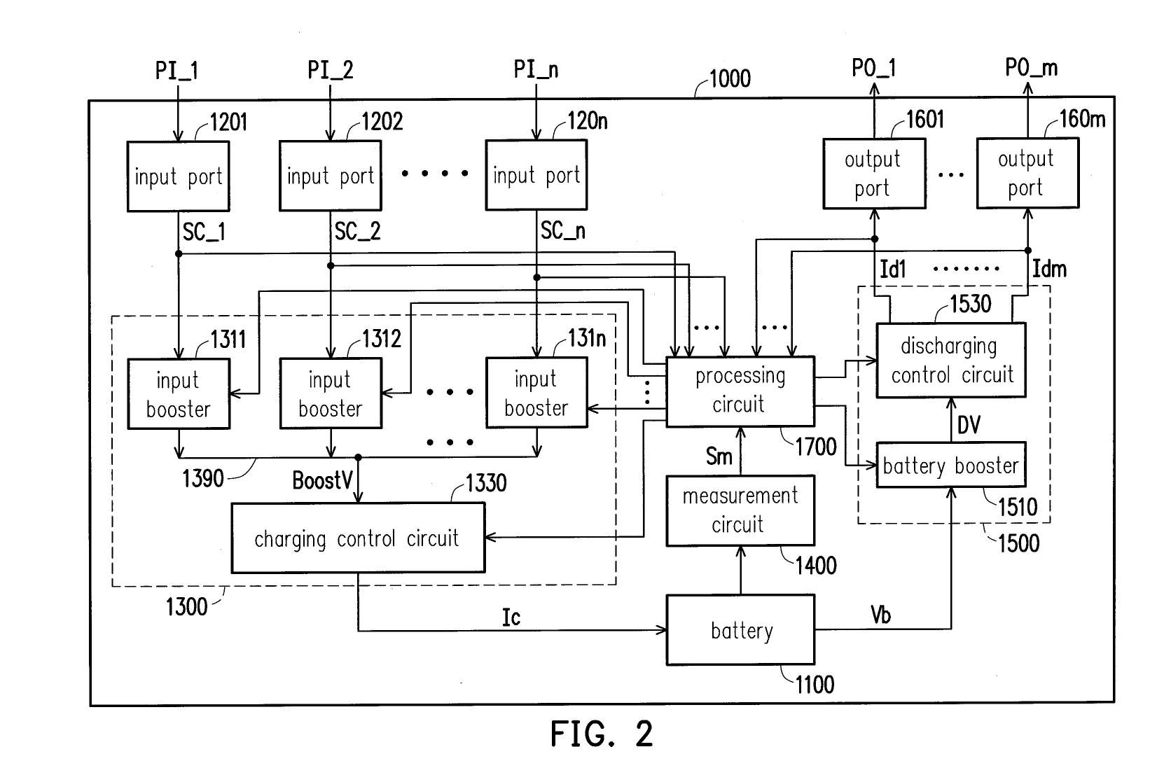

Please refer to FIG. 2, which is a schematic block diagram illustrating details of the fast charging power bank 1000 depicted in FIG. 1. As shown in FIG. 2, the fast charging power bank 1000 includes the battery 1100, the input ports 1201-120n, the measurement circuit 1400, the output ports 1601-160m, and the processing circuit 1700, and the descriptions of these elements are provided above and shown in FIG. 1 and thus will not be further provided. The charging control unit 1300 will be further elaborated hereinafter. The description of the discharging control unit 1500 will then follow.

The charging control unit 1300 includes a plurality of input boosters 1311-131n and a charging control circuit 1330. The input boosters 1311-131n are connected to each other in parallel. An input terminal of each of the input boosters 1311-131n is correspondingly connected to an independent one of the input ports 1201-120n to receive one of the charging powers SC_1-SC_n. An output terminal of each of the input boosters 1311-131n is connected to each other and connected to a boost bus 1390. The input boosters 1311-131n step up voltages of the charging powers SC_{—} 1-SC_n respectively and output a boosting voltage BoostV to the boost bus 1390. Each of the input boosters 1311-131n controls the current of each of the charging powers SC_1-SC_{—} to balance the input powers PI_1-PI_n and prevent overload of the input powers PI_1-PI_n. The charging control circuit 1330 is connected between the boost bus 1390 and the battery 1100. The charging control circuit 1330 serves to receive the boosting voltage BoostV. Besides, the charging control circuit 1330 converts the boosting voltage BoostV into a charging current Ic and outputs the charging current Ic to the battery 1100, so as to charge the battery 1100.

Specifically, the input booster 1311 is correspondingly connected to an independent one of the input ports (e.g., the input port 1201) to receive one of the charging powers (e.g., the charging power SC_1). The input booster 1311 steps up the voltage of the charging power SC_1 to generate the boosting voltage BoostV and outputs the boosting voltage BoostV to the boost bus 1390. Similarly, the input booster 1312 is correspondingly connected to an independent one of the input ports (e.g., the input port 1202) to receive one of the charging powers (e.g., the charging power SC_2). The input booster 1312 steps up the voltage of the charging power SC_2 to generate the boosting voltage BoostV and outputs the boosting voltage BoostV to the boost bus 1390. Details of the other input boosters 1313-131n may be deduced from the above descriptions. Since the input boosters 1311-131n are connected to the charging control circuit 1330 in parallel through the boost bus 1390, the charging control circuit 1330 is able to add up the currents provided by the input boosters 1311-131n to the boost bus 1390. The charging control circuit 1330 is configured to convert the boosting voltage BoostV into the charging current Ic.

According to an embodiment of the invention, the processing circuit 1700 is connected to the input boosters 1311-131n and the charging control circuit 1330. The processing circuit 1700 controls the input boosters 1311-131n based on a plurality of detection results of the charging powers SC_1-SC_n, so as to allow the input boosters 1311-131n to generate the boosting voltage BoostV. The processing circuit 1700 controls the charging control circuit 1330 based on the measurement signal Sm, so as to generate the charging current Ic. In particular, as provided above, the processing circuit 1700 is able to detect whether the external power supply is connected to the input ports 1201-120n according to the charging powers SC_1-SC_n. If the processing circuit 1700 determines the external power supply is connected to the input ports 1201-120n, the processing circuit 1700 controls the input boosters 1311-131n respectively, so as to allow the input boosters 1311-131n to generate the boosting voltage BoostV.

For instance, it is assumed that the input port 1201 receives an input power PI_1 as the charging power SC_1 from an external power supply, the charging power SC_1 has the voltage at 5 volts and the current in 2 amperes (i.e., the power is 10 watts), the processing circuit 1700 controls the boosting voltage BoostV output by the input boosters 1311-131n to be at 10 volts, and the fully charged battery 1100 has the voltage at 4 volts. The processing circuit 1700 can determine the external power supply is connected to the input port 1201 according to the charging power SC_1. Hence, the processing circuit 1700 is able to control the input booster 1311 to step up the voltage of the charging power SC_1, so as to generate the boosting voltage BoostV.

In accordance with the Law of Conservation of Energy, after stepping up the voltage of the charging power SC_1 (e.g., to 10 volts), the input booster 1311 outputs the current at 1 ampere to the charging control circuit 1330. The charging control circuit 1330 then converts the boosting voltage BoostV (at 10 volts) provided by the input booster 1311. Since the voltage of the fully charged battery 1100 is 4 volts, the charging control circuit 1330 is required to step down the boosting voltage BoostV (at 10 volts). Similarly, in accordance with the Law of Conservation of Energy, the charging control circuit 1330 generates the charging current Ic at 2.5 amperes. That is, the charging control circuit 1330 charges the battery 1100 with the current at 2.5 amperes.

In view of the foregoing, another input port 1202 is assumed to receive the input power PI_2 as the charging power SC_2 from another external power supply, and the charging power SC_2 has the voltage at 5 volts and the current at 1 ampere (i.e., the power is 5 watts). The processing circuit 1700 can determine another external power supply is connected to the input port 1202 according to the charging power SC_2. Hence, the processing circuit 1700 is able to control the input booster 1312 to step up the voltage of the charging power SC_2, so as to generate the boosting voltage BoostV.

In accordance with the Law of Conservation of Energy, after stepping up the voltage of the charging power SC_2 (e.g., to 10 volts), the input booster 1312 outputs the current at 0.5 ampere to the charging control circuit 1330. Since the input booster 1311 outputs the current at 1 ampere to the charging control circuit 1330, the input boosters 1311 and 1312 in total provide the current at 1.5 ampere (i.e., 15 watts of power) to the charging control circuit 1330. The charging control circuit 1330 then converts the boosting voltage BoostV (at 10 volts) provided by the input boosters 1311 and 1312. Since the voltage of the fully charged battery 1100 is 4 volts, the charging control circuit 1330 is required to switch-step down the boosting voltage BoostV (at 10 volts). Similarly, in accordance with the Law of Conservation of Energy, the charging control circuit 1330 generates the charging current Ic at 3.75 amperes (obtained by dividing 4 volts from 15 watts). That is, the charging control circuit 1330 charges the battery 1100 with the current at 3.75 amperes.

As described above, the charging current provided to the battery 1100 of the power bank 1000 through plural input ports (e.g., simultaneously through the input ports 1201 and 1202) is greater than the charging current provided to the battery 1100 through one single input port (e.g., merely through the input port 1201). In other words, simultaneous use of plural input ports 1201-120n leads to an increase in the charging current of the battery 1100, which significantly accelerates the charging action on the battery 1100 and reduces the time spent on fully charging the battery 1100. Note that the conditions described above, i.e., the charging power SC_1 has the voltage at 5 volts and the current at 2 amperes, the charging power SC_21 has the voltage at 5 volts and the current at 1 ampere, the boosting voltage BoostV is 10 volts, and the voltage of the fully charged battery 1100 is 4 volts, are exemplary and should not be construed as limitations to the invention.

With reference to FIG. 2, the input boosters 1311-131n may be respectively controlled by the processing circuit 1700 to generate the stable boosting voltage BoostV, and thereby the input boosters 1311-131n are allowed to respectively adjust the current provided to the charging control circuit 1330.

Said exemplary conditions are applied to further elaborate the invention. If the charging power SC_1 has the voltage at 5 volts and the current at 2 amperes, the input booster 1311 can be controlled by the processing circuit 1700 to generate the boosting voltage BoostV at 10 volts and output the current at 1 ampere to the charging control circuit 1330. Under some circumstances, if the input power PI_1 (i.e., the charging power SC_1) provided by the external power supply is unstable, e.g., from 2 amperes down to 1.6 ampere, the processing circuit 1700 may control the input booster 1311 according to the detection result of the charging power SC_1. Particularly, the processing circuit 1700 at this time can control the input booster 1311 to maintain the boosting voltage BoostV at 10 volts. However, the processing circuit 1700 controls the input booster 1311 to merely provide the current at 0.8 ampere to the charging control circuit 1330. Detailed operations of the other input boosters 1312-131n may be deduced from the above descriptions.

Thereby, the processing circuit 1700 is able to learn the maximum stable power that can be provided by each external power supply (e.g., the external power supply connected to the input port 1201) according to the detection results of the charging powers SC_1-SC_n (e.g., the charging power SC_1). In the above embodiment, the maximum stable power that can be output from the input booster 1311 or from the external power supply connected to the input port 1201 is 8 watts (obtained by multiplying 5 volts by 1.6 ampere or by multiplying 10 volts by 0.8 ampere). Since the processing circuit 1700 is able to learn the maximum stable power that can be output from the external power supplies connected to the input ports, the processing circuit 1700 can control the charging control circuit 1330 to generate the maximum stable charging current Ic.

In addition to the above, the processing circuit 1700 can further control each input booster to be switched on or off. For instance, when the processing circuit 1700 intends to raise the charging current of the battery 1100, the processing circuit 1700 may simultaneously switch on plural input boosters (e.g., two or more) or switch on plural input boosters that are capable of providing large stable powers (e.g., at 10 watts). Thereby, the charging control circuit 1330 is able to add up the powers provided by the input boosters that are switched on, and the charging control circuit 1330 converts the powers into the charging currents for charging the battery 1100. By contrast, the processing circuit 1700 can merely switch on one input booster or switch on the input booster that is capable of providing small stable powers (e.g., at 5 watts), so as to reduce the charging current of the battery 1100.

The discharging control unit 1500 will be further elaborated hereinafter. As shown in FIG. 2, the discharging control unit 1500 includes a battery booster 1510 and a discharging control circuit 1530. The battery booster 1510 is connected to the battery 1100 and the processing circuit 1700. Besides, the battery booster 1510 is controlled by the processing circuit 1700 to step up the voltage Vb of the battery 1100 and accordingly generate a discharging voltage DV. The discharging control circuit 1530 is connected to the battery booster 1500, the processing circuit 1700, and at least one of the output ports 1601-160m. Here, the discharging control circuit 1530 serves to receive the discharging voltage DV. The discharging control circuit 1530 is controlled by the processing circuit 1700, so as to convert the discharging voltage DV into at least one discharging current Id1-Idm. The discharging control circuit 1530 then provides the at least one discharging current Id1-Idm to the output ports 1601-160m. The discharging control circuit 1530 can detect the at least one discharging current Id1-Idm to perform an overload detection on the output ports 1601-160m.

For instance, if the voltage Vb of the battery 1100 is 4 volts, and if the processing circuit 1700 detects that one mobile apparatus (not shown) is connected to the output port 1601, the processing circuit 1700 can control the battery booster 1510 to step up the voltage Vb (at 4 volts) of the battery 1100, so as to generate the discharging voltage DV (e.g., at 5 volts, the USB voltage level). The discharging control circuit 1530 converts the discharging voltage DV into the discharging current Id1. Thereby, the discharging current Id1 can be provided to the mobile apparatus through the output port 1601.

To sum up, the fast charging power bank provided herein is able to receive the input powers as the charging powers from the external power supplies through the input ports. Hence, large charging current can be provided to the battery in the power bank. Thereby, the charging action performed on the battery can be accelerated, and the charging time of the battery can be reduced. Moreover, each input booster is connected to one independent input port corresponding to the input booster to receive the charging power; accordingly, the processing circuit is able to control each input booster to be switched on or off, so as to control the charging current of the battery.

Although the invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A fast charging power bank comprising:
at least one battery;
a plurality of input ports configured to respectively receive a plurality of input powers as a plurality of charging powers from a plurality of external power supplies; and
a charging control unit comprising:
a plurality of input boosters connected to each other in parallel, an input terminal of each of the input boosters being correspondingly connected to an independent one of the input ports to receive one of the charging powers, an output terminal of each of the input boosters being connected to each other and connected to a boost bus, the input boosters respectively stepping up voltages of the charging powers to output a boosting voltage and control currents of the charging powers, so as to balance the input powers and prevent overload of the input powers; and
a charging control circuit connected between the boost bus and the at least one battery, the charging control circuit being configured to control the boost bus, convert the boosting voltage into a charging current, and output the charging current to the at least one battery, so as to charge the at least one battery.

2. The fast charging power bank of claim 1, further comprising:
a measurement circuit connected to the at least one battery to measure a voltage and a current of the at least one battery and generate a measurement signal; and
a processing circuit connected to the input boosters, the charging control circuit, and the measurement circuit,
wherein the input boosters are respectively controlled by the processing circuit to generate the boosting voltage,
and the processing circuit receives the measurement signal and controls the charging control circuit based on the measurement signal, so as to generate the charging current.

3. The fast charging power bank of claim 2, wherein the processing circuit is further connected to the input ports to detect the charging powers and respectively control the input boosters based on a plurality of detection results of the charging powers, so as to control the currents of the charging powers and control the input boosters to generate the boosting voltage.

4. The fast charging power bank of claim 3, wherein the processing circuit obtains a maximum stable power output by each of the external power supplies according to the detection result of each of the charging powers.

5. The fast charging power bank of claim 3, wherein the processing circuit controls a current of each of the input boosters to adjust the charging current.

6. The fast charging power bank of claim 3, further comprising:
a discharging control unit comprising:
a battery booster connected to the at least one battery and the processing circuit, the battery booster being controlled by the processing circuit to step up the voltage of the at least one battery and accordingly generate a discharging voltage; and
a discharging control circuit connected to the battery booster and the processing circuit, the discharging control circuit being controlled by the processing circuit to output the discharging voltage and at least one discharging current to at least one mobile apparatus.

7. The fast charging power bank of claim 6, further comprising:
at least one output port connected to the discharging control circuit to receive the at least one discharging current and output the at least one discharging current for charging the at least one mobile apparatus,
wherein the discharging control circuit detects the at least one discharging current to perform an overload detection on the at least one output port.

8. The fast charging power bank of claim 7, wherein
the processing circuit obtains a current capacity of the at least one battery according to the measurement signal,
the processing circuit controls the charging control circuit to stop generating the charging current if the current capacity of the at least one battery is greater than an input threshold, and
the processing circuit controls the discharging control circuit to stop charging the at least one mobile apparatus if the current capacity of the at least one battery is less than a battery threshold.

9. The fast charging power bank of claim 7, wherein each of the input ports or each of the at least one output port is a universal serial bus port, and the universal serial bus port is a micro universal serial bus port, a mini universal serial bus port, or a universal serial bus type C port.
